(19) United States
(12) Patent Application Publication
(10) Pub. No.: US 2009/0256748 A1
(43) Pub. Date: Oct. 15, 2009

(54) WIRELESS DISTRIBUTION OF DATA AND CONTROL

(76) Inventors: Roberto W. Alm, Windham, NH (US); Angelo M. Puzella, Marlborough, MA (US); Mark E. Stading, Aliso Viejo, CA (US)

Correspondence Address: RAYTHEON COMPANY;c/o DALY, CROWLEY, MOFFORD & DURKEE, LLP, 354A TURNPIKE STREET, SUITE 301A, CANTON, MA, 02021-2714, US

(21) Appl. No.: 12/102,773

(22) Filed: Apr. 14, 2008

(51) Int. Cl. H01Q 3/00

(52) U.S. Cl. 342/377

(57) ABSTRACT

A phased array system having a plurality of array elements, a beam steering computer; at plurality of attenuation and phase control elements for controlling attenuation and phase of energy passing through such attenuation and phase control elements, and a feed network for feeding phase and attenuation data to the plurality of attenuation and phase control elements. The feed network includes at least one slave, wireless receive unit connected to a corresponding one of the plurality of attenuation and phase control elements; and a master wireless transmit unit coupled to the beam steering computer and in wireless communication with the at least one of the plurality of slave, wireless receive units, for transmitting the phase and attenuation data from the beam steering unit to the at least one of the plurality of attenuation and phase control elements. The slave wireless receive unit and the master transmit unit are a spread spectrum communication system. The one slave wireless receive unit and the master transmit unit are Bluetooth units.

### TECHNICAL FIELD

This invention relates generally to phased array systems and more particularly to systems and method for distributing data and control information to elements in such phased array systems.

### BACKGROUND

As is known in the art, present phased-array systems for communications, radar, seekers, etc. employ a direct hard wire routing method from a digital information node (such as a “Beam Steering Computer” or other digital interface port) to the individual transmit/receive elements (T/R) in the system. “Individual Elements”, as described here, may represent a single Transmit/Receive (T/R) function realized as an element of a greater system, or it may represent a group of elements within a greater array structure. As is also known in the art, phased array antenna systems are adapted to produce a beam of radio frequency energy (RF) and direct such beam along a selected direction by controlling the phase of the energy passing between a transmitter/receiver and an array of antenna elements through a plurality of phase shifter sections. This direction is provided by sending a control word (i.e., data representative of the desired phase shift, as well as attenuation and other control data) to each of the T/R element. Such control word has been sent to the T/R elements through electrical wires or opto-electronics cables (i.e., fiber optic cables). FIG. 1 shows phased array antenna radar system and FIG. 2 illustrates the problem associated with directly routing data, clock, control and other digital signals to the elements of the radar system in FIG. 1 within the tight confines of the phased-array system. As shown in FIG. 2 therein, the communication between the elements and the beam steering computer is with routing of hard wire signal and control lines. The problem becomes more difficult as operating frequency increases because the physical size of the may is often resulting in systems requiring circuit boards with high layer counts.

### SUMMARY

In accordance with the present invention, a phased array system is provided having a plurality of array elements. The system includes: a beam steering computer; at plurality of attenuation and phase control elements for controlling attenuation and phase of energy passing through such attenuation and phase control elements; and a feed network for feeding phase and attenuation data to the plurality of attenuation and phase control elements. The feed network includes at least one slave, wireless receive unit connected to a corresponding one of the plurality of attenuation and phase control elements; and a master wireless transmit unit coupled to the beam steering computer and in wireless communication with the at least one of the plurality of slave, wireless receive units, for transmitting the phase and attenuation data from the beam steering unit to the at least one of the plurality of attenuation and phase control elements.

In one embodiment, a phased array system is provided having: a plurality of array elements; a beam steering computer; a plurality of attenuation and phase control elements for controlling attenuation and phase of energy passing through such attenuation and phase control elements; a feed network for feeding phase and attenuation data to the plurality of attenuation and phase control elements, such network comprising a plurality of slave, wireless receive units, each one of such receive units being connected to the plurality of attenuation and phase control elements; and a master wireless transmit unit coupled to the beam steering computer and in wireless communication with the plurality of slave, wireless receive units, for transmitting the phase and attenuation data from the beam steering unit to the plurality of a plurality of attenuation and phase control elements.

In one embodiment, each one of the plurality of attenuation and phase control elements has a unique address and wherein the master wireless transmit unit transmits an address along with the data to the plurality of attenuation and phase control for detection by one of the plurality of attenuation and phase control elements.

In one embodiment, the slave wireless receive units and the master transmit unit communicate using spread spectrum communication.

In one embodiment, the slave wireless receive units and the master transmit unit are Bluetooth units.

With such an arrangement, the difficulties associated with direct hard wire routing of digital data and control signals to elements within a phased-array structure could be greatly reduced through the use of a wireless communication system. In one embodiment the wireless communication system is a spread-spectrum wireless communication system, such as a “Bluetooth” communication system that can transmit the digital data, clock and control signals to small Bluetooth receiver(s) embedded within array elements.

In one embodiment, a “Bluetooth” receiver is an integral part of the chip or chip-set within a T/R element of the phased array system.

One of the major concerns associated with opening the data and control environment of a phased-array system to a wireless technology is susceptibility to interference and jamming. Since Bluetooth technology was specifically developed for use in congested environment and secure wireless LAN applications, advanced spread-spectrum and digital encoding and encrypting techniques have already been implemented within the technology to provide for interference-free operation, and risk of susceptibility to loss of control of the system is minimal.

Using Bluetooth digital interconnect technology as shown in FIG. 2 would also greatly reduces the number of connector interfaces in practical phased-array systems (as compared to traditional direct-routing.) Connector interfaces tend to be bulky and expensive, and are often the limiting factor for size and/or cost reduction efforts—Especially at higher frequencies. This approach (whether realized in “slat” or “tile” configuration) provides opportunity for cost savings and enables smaller, lighter-weight systems. The smaller size also makes this a natural fit for higher frequency systems, and could also enable smaller, light-weight portable systems that can be utilized in localized areas that could be used for a wide variety of applications.

The overall performance and operating speed of a phased-array application improves through elimination of the parasitic degradation of data, clock and control signals being directly routed through complex interconnect mechanisms. The Bluetooth transceiver maintains data integrity and provides a much cleaner interface of the digital signals at the element level since it will be located within the array or within the T/R element itself.

As phased-array communications, radar and seeker systems find new applications at higher frequencies, a method of providing low-cost data, clock and control routing becomes more important. This approach also provides a vehicle for integration of proven silicon-based technology in integrated systems that may also employ GaAs, GaN or other III-V or II-VI compounds in the future.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a phased array antenna system according to the PRIOR ART;

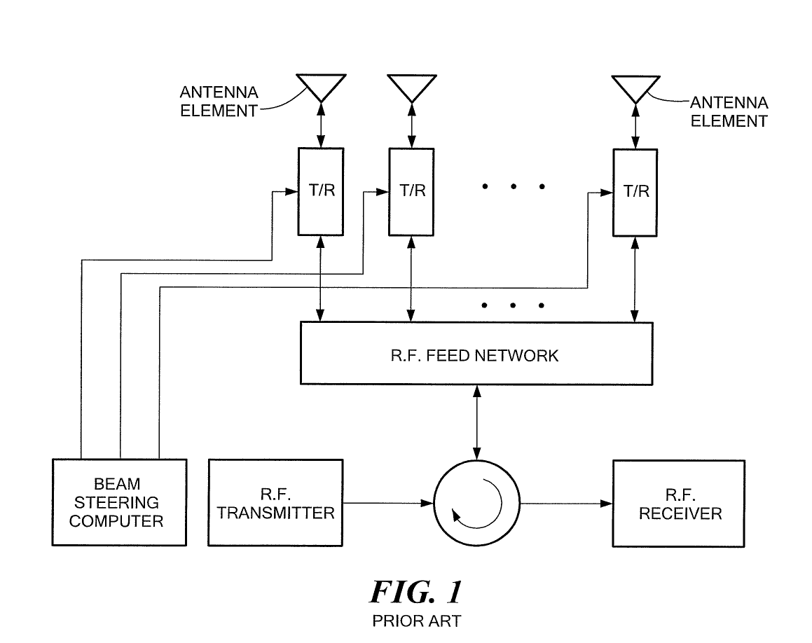

FIG. 2 is a block diagram of a system for communication data and control information to transmit/receive elements of the pashed array antenna system of FIG. 1 according to the PRIOR ART;

FIG. 3 is a block diagram of a phased array antenna system according to the invention;

FIG. 4 is a block diagram of a system for communication data and control information to transmit/receive elements of the pashed array antenna system of FIG. 1 according to the invention.

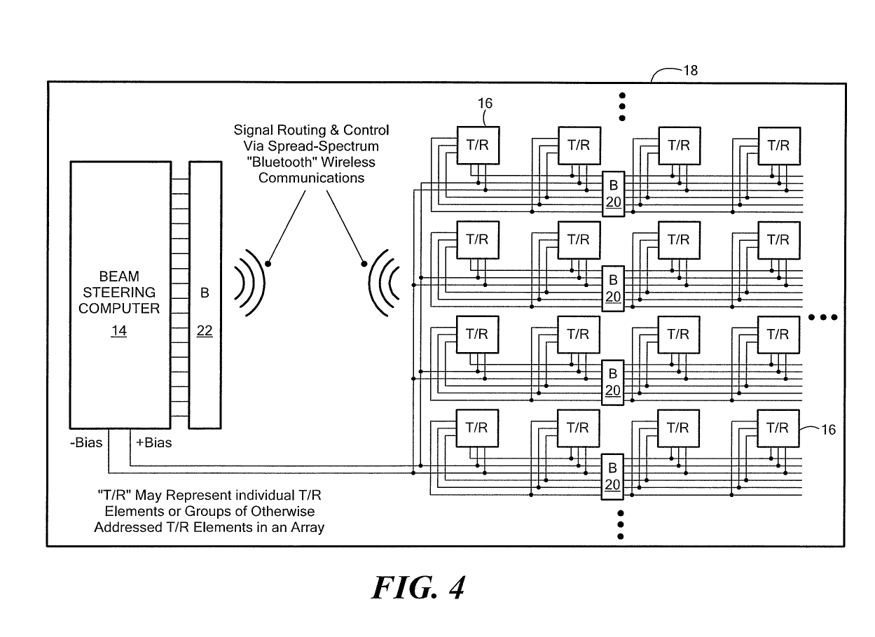

Like reference symbols in the various drawings indicate like elements.

### DETAILED DESCRIPTION

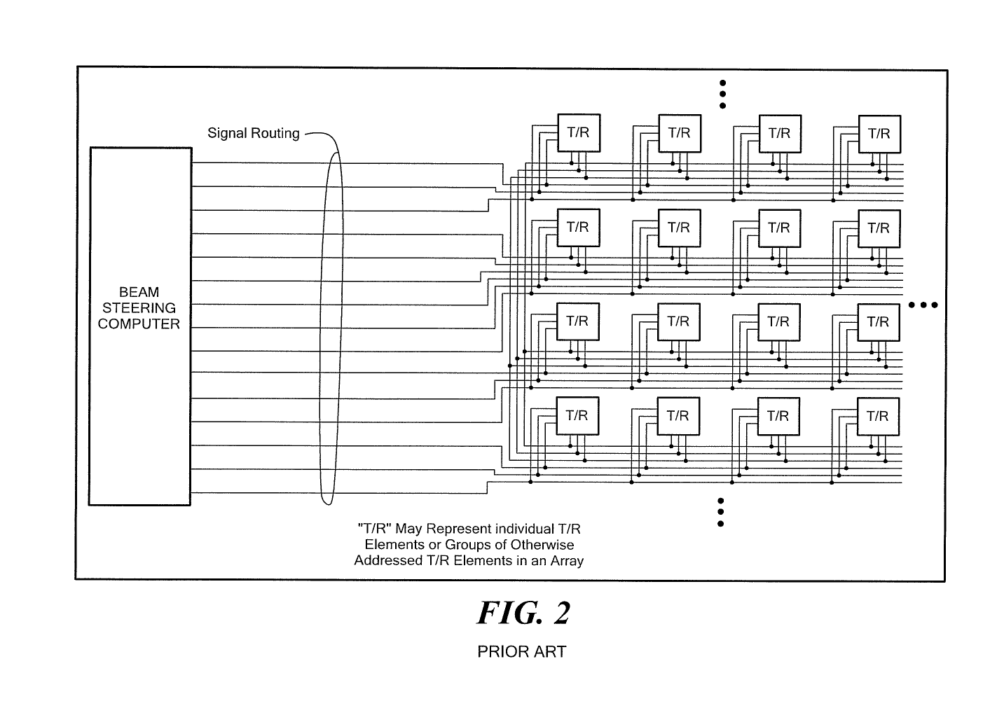

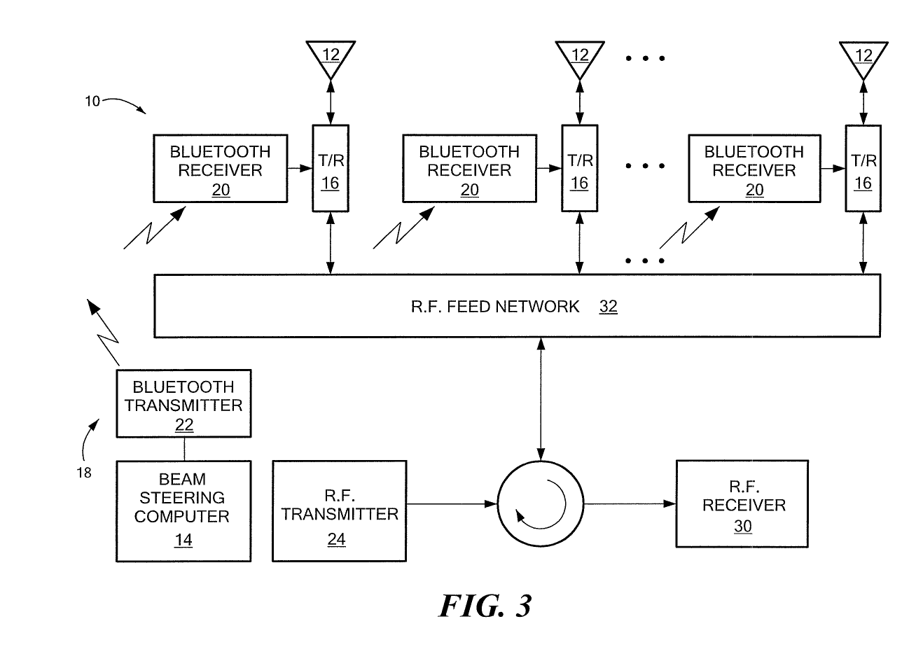

Referring now to FIGS. 2 and 3, a phased array system, 10 here a phased array antenna in a radar system, is shown to include: a plurality of array elements 12; a beam steering computer 14; a plurality of attenuation and phase control elements 16, herein sometimes referred to as T/R elements) for controlling attenuation and phase of energy, here R. F. energy passing through such attenuation and phase control elements 16; a feed network 18 for feeding phase and attenuation data to the plurality of attenuation and phase control elements 16. The feed network 18 comprising a plurality of slave, wireless receive units 20, each one of such receive units 20 being connected to a corresponding one of the plurality of attenuation and phase control elements 16; and a master wireless transmit unit 22 coupled to the beam steering computer 14 and in wireless communication with the plurality of slave, wireless receive units 20, for transmitting the phase and attenuation data from the beam steering unit 14 to the plurality of attenuation and phase control elements 16.

The phased array antenna system 10 is adapted to produce a beam of radio frequency energy (RF) and direct such beam along a selected direction by controlling the phase of the energy passing between the transmitter 24, during a transmit mode, or the receiver 30, during a receive mode, and the array of antenna elements 12 through an R. F. feed network 32 and the T/R elements 16. The direction is provided by the beam steering computer 14 sending a control word (i.e., data representative of the desired phase shift, as well attenuation and other control data) to each of the T/R elements 16.

Here the control words are transmitted by the master wireless transmit unit 22 coupled to the beam steering computer 32 and in wireless communication with the plurality of slave, wireless receive units 20. The wireless receive units 20 are connected to the T/R elements 16. Thus, the wireless transmit unit 22 transmits the phase and attenuation data and control signals from the beam steering unit 22 to the T/R elements 16 to thereby enable such T/R elements 16 to adjust the attenuation and phase shift of the R. F. energy passing through such T/R elements 16. Each one of the plurality of attenuation and phase control elements 16 has a unique address and the master wireless transmit unit 22 transmits an address along with the data to the plurality of attenuation and phase control elements 16 for detection by one of the plurality of attenuation and phase control elements 16.

Here, the slave wireless receive units 20 and the master transmit unit 22 communicate using spread spectrum communication. Here, the slave wireless receive units 20 and the master transmit unit 22 are Bluetooth units. The Bluetooth receiver unit 22 is here an integral part of the chip or chip-set within corresponding the T/R element 16 of the phased array system.

A number of embodiments of the invention have been described. Nevertheless, it will be understood that various modifications may be made without departing from the spirit and scope of the invention. For example, a mesh network may be used wherein the beam steering computer 14 communicates with a nearest receive unit 20 then from there the other receive units 20 would not necessarily have to depend on the beam steering computer but each would have a “repeater” transmitter to communicate to their nearest neighbor until every receive unit received the communication. Accordingly, other embodiments are within the scope of the following claims.

What is claimed is:

1. A phased array system comprising:
a plurality of array elements;
a beam steering computer;
at plurality of attenuation and phase control elements for controlling attenuation and phase of energy passing through such attenuation and phase control elements;
a feed network for feeding phase and attenuation data to the plurality of attenuation and phase control elements, such network comprising at least one slave, wireless receive unit connected to a corresponding one of the plurality of attenuation and phase control elements; and
a master wireless transmit unit coupled to the beam steering computer and in wireless communication with the at least one of the plurality of slave, wireless receive units, for transmitting the phase and attenuation data from the beam steering unit to the at least one of the plurality of attenuation and phase control elements.

2. The system recited in claim 1 wherein the at least one slave wireless receive unit and the master transmit unit are a spread spectrum communication system.

3. The system recited in claim 1 wherein the at least one slave wireless receive unit and the master transmit unit are Bluetooth units.

4. A phased array system comprising:
a plurality of array elements;
a beam steering computer;
at plurality of attenuation and phase control elements for controlling attenuation and phase of energy passing through such attenuation and phase control elements;
a feed network for feeding phase and attenuation data to the plurality of attenuation and phase control elements, such network comprising a plurality of slave, wireless receive units each one being connected to a corresponding one of the plurality of attenuation and phase control elements; and
a master wireless transmit unit coupled to the beam steering computer and in wireless communication with the plurality of slave, wireless receive units, for transmitting the phase and attenuation data from the beam steering unit to the plurality of attenuation and phase control elements.

5. The system recited in claim 4 wherein each one of the plurality of attenuation and phase control elements has a unique address and wherein the master wireless transmit unit transmits an address along with the data to the plurality of attenuation and phase control for detection by one of the plurality of attenuation and phase control elements.

6. The system recited in claim 5 wherein each one of the slave receiver units is an integral part of the chip or chip-set within a corresponding one of the transmit/receiver elements.

7. The system recited in claim 4 wherein the at least one slave wireless receive unit and the master transmit unit are a spread spectrum communication system.

8. The system recited in claim 4 wherein the at least one slave wireless receive unit and the master transmit unit are Bluetooth units.
